(19) United States
(12) Patent Application Publication
(10) Pub. No.: US 2008/0160435 A1
(43) Pub. Date: Jul. 3, 2008

(54) ELECTROPHOTOGRAPHIC IMAGE FORMING METHOD USING TRANSPARENT TONER

(75) Inventors: Young-taek LIM, Seoul (KR); Jong-woo Park, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/849,477

(22) Filed: Sep. 4, 2007

(30) Foreign Application Priority Data
Dec. 28, 2006 (KR) 2006-136807

(51) Int. Cl. G03G 13/04

(52) U.S. Cl. 430/48

(57) ABSTRACT

A printing method to form an electrophotographic image includes applying a transparent toner image to a surface of a printing medium, applying color toner images on the transparent toner image according to image information, and applying another transparent toner image onto the color toner images.

### CROSS-REFERENCE TO RELATED APPLICATIONS

This application claims the benefit of priority under 35 U.S.C. § 119(a) of Korean Patent Application No. 10-2006-0136807, filed on Dec. 28, 2006, in the Korean Intellectual Property Office, the disclosure of which incorporated herein in its entirety by reference.

### BACKGROUND OF THE INVENTION

1. Field of the Invention

The present general inventive concept relates to printing on an image forming apparatus and method, and more particularly, to an electrophotographic image forming apparatus and method to form an image using a transparent toner.

2. Description of the Related Art

Electrophotographic image forming apparatuses form an electrostatic latent image by scanning light onto a photosensitive body charged to a uniform electric potential, developing the electrostatic latent image with a predetermined color of toner and then transferring the developed image to, and fusing the developed image on a printing medium, thereby printing a desired image. In general, four colors of toners, such as yellow (Y), magenta (M), cyan (C), and black (B), are used in electrophotographic color image forming apparatuses, and four developing units are used to develop the electrostatic latent image formed on the photosensitive body with these four colors of toners.

A toner is manufactured based on a plastic resin and thus forms a glossy finish in the printed image. Consequently, a portion of a printed image to which the toner is attached has some gloss, but a background region of the printed image to which the toner is not attached has no gloss. In addition, higher coverage (the ratio of an area to which the toner is attached to the area of the printing medium) of the printed image results in higher gloss in the printed image. The gloss of the printed image affects the visual quality of the image. Certain image forming apparatuses feature a transparent image forming station to improve the gloss of a printed image by employing developing devices that develop electrostatic images with color toners and a developing device that develops an electrostatic image with a transparent toner.

FIG. 6 illustrates an example of a conventional printing method using color toners and a transparent toner. Referring to FIG. 6, color toner images of yellow (Y), magenta (M), and cyan (C) are transferred to an intermediate transfer medium 1. Subsequently, a toner image of black (B) is transferred to the color toner images, and a transparent (T) toner image is transferred to the location at which the toner image of black (B) is not transferred. As such, both the color toner images and the transparent (T) toner image are formed on the intermediate transfer medium 1. When the color toner images are transferred to a printing medium 2, the transparent (T) toner image and the black (B) toner image are positioned on the lowest layer and yellow (Y), magenta (M), and cyan (C) toner images are positioned on the transparent (T) toner image and the black (B) toner image. According to such a printing method, since color toners are positioned on the uppermost layer on the printing medium, the gloss effect of the transparent toner is diminished and the gloss of the printed image cannot be sufficiently improved.

FIG. 7 illustrates another example of a conventional printing method using color toners and a transparent toner. Referring to FIG. 7, after a yellow (Y) toner image and a transparent (T) toner image, a magenta (M) toner image and a transparent (T) toner image, a cyan (C) toner image and a transparent (T) toner image, and a black (B) toner image and a transparent (T) toner image are sequentially transferred to the intermediate transfer medium 1, color toner images are transferred to a printing medium 2. Since color toner images, e.g. the yellow (Y) region, occupy the uppermost layer on the printing medium 2 even using this printing method, the gloss effect from the transparent toner is diminished and the gloss of a printed image cannot be sufficiently improved.

### SUMMARY OF THE INVENTION

The present general inventive concept provides a printing method to form an electrophotographic image that prevents color toner images from occupying the uppermost layer.

The present general inventive concept also provides a printing method to form an electrophotographic image in which a secret printing operation can be performed on a portion of an image or on an entire image.

The present general inventive concept also provides an electrophotographic image forming apparatus that applies transparent toner to the uppermost layer of the printed image, as well as to background regions of the printed image.

The present general inventive concept also provides an electrophotographic image forming apparatus that distorts a secret region of a printed image and leaves undistorted a viewable region of the printed image.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a printing method to form an electrophotographic image including transferring a second transparent toner image to a surface of a printing medium, transferring color toner images on the second transparent toner image according to image information, and transferring a first transparent toner image onto the color toner images.

The second transparent toner image may be transferred only to a region of the printing medium on which the color toner images are transferred.

The first transparent toner image may be transferred only to a region of the printing medium on which the color toner images are transferred.

The first transparent toner image may be transferred to a region of the printing medium on which the color toner images are transferred and a background region of the printing medium in which the color toner images are not transferred.

The second transparent toner image may be transferred to the entire surface of the printing medium. The first transparent toner image may be transferred only to a region of the surface of the printing medium on which the color toner images are transferred.

The foregoing and/or other aspects and utilities of the present general inventive concept are also achieved by providing a printing method to form an electrophotographic image including dividing a printed image into a viewable printing region and a secret printing region and sequentially transferring a transparent toner image, color toner images, and another transparent toner image onto a region of the printing medium corresponding to the secret printing region, passing the printing medium through a fusing unit and fusing the printed image on the printing medium, and distorting the image in the secret printing region by applying heat to the printing medium.

The distorting of the image in the secret printing region may further include repeating the passing the printing medium through the fusing unit subsequent to the fusing operation being performed.

The foregoing and/or other aspects and utilities of the present general inventive concept are also achieved by providing a method to form an electrophotographic image including applying at least one color toner to a printing medium in regions thereon corresponding to image data, and applying transparent toner to the color toner in the regions corresponding to the image data.

The foregoing and/or other aspects and utilities of the present general inventive concept are also achieved by providing a method to form an electrophotographic image comprising providing a transparent toner to regions of an electrostatic latent image corresponding to colored regions of a printed image, and providing at least one colored toner to the regions of the electrostatic latent image corresponding to the colored regions of the printed image, the colored toner being applied over the transparent toner on the electrostatic latent image.

The foregoing and/or other aspects and utilities of the present general inventive concept are also achieved by providing a method to distort regions of a printed image including applying a first toner layer having a first melting point to a printing medium, applying a second toner layer having a second melting point greater than the first melting point on the first toner in regions thereon corresponding to the printed image, applying a third toner layer having a third melting point less than the second melting point on the second toner layer on at least the regions thereof corresponding to the printed image, and applying heat to the printing medium to move the second toner layer between the first toner layer and the third toner layer prior to the melting of the second toner layer and subsequent to the melting of the first toner layer and the second toner layer.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates an exemplary structure of a single pass color image forming apparatus implemented by using a printing method to form an electrophotographic image according to an embodiment of the present general inventive concept;

FIG. 2 illustrates an electric potential of the surface of an exemplary exposed photosensitive drum;

FIGS. 3A, 3B, and 3C respectively illustrate an operation of transferring a first transparent toner image and color toner images to a printing medium via an intermediate transfer medium;

FIGS. 3D and 3E respectively illustrate an operation of transferring a first transparent toner image, color toner images, and a second transparent toner image to the printing medium via the intermediate transfer medium;

FIG. 4 illustrates an exemplary structure of a single pass color image forming apparatus employing a direct transfer technique implemented by using a printing method to form an electrophotographic image according to another embodiment of the present general inventive concept;

FIG. 5 illustrates an exemplary structure of a multiple pass color image forming apparatus implemented by using a printing method to form an electrophotographic image according to another embodiment of the present general inventive concept;

FIGS. 6 and 7 respectively illustrate conventional printing methods.

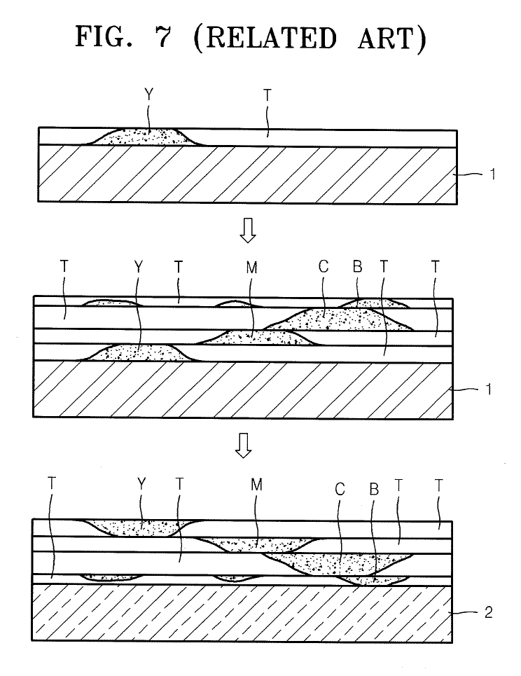

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

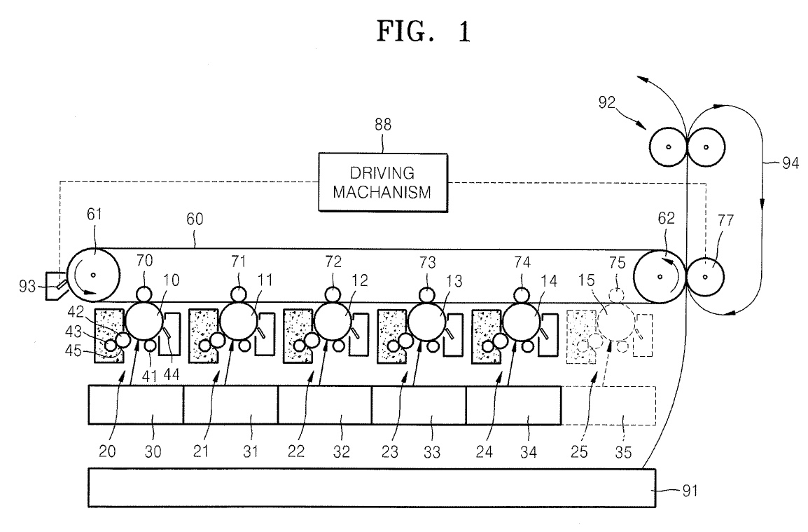

FIG. 1 illustrates a structure of an electrophotographic image forming apparatus consistent with printing an image according to an exemplary embodiment of the present general inventive concept. Referring to FIG. 1, the electrophotographic image forming apparatus according to this exemplary embodiment is a single pass color image forming apparatus which comprises a photosensitive drum 10, an exposing unit 30, and a developing unit 20 which are used to develop a transparent toner image, and photosensitive drums 11, 12, 13, and 14, exposing units 31, 32, 33, and 34, and developing units 21, 22, 23, and 24, which are used to develop color toner images. A transparent toner may be maintained in the developing unit 20. Color toners such as black (B), magenta (M), cyan (C), and yellow (Y) may be maintained in the developing units 21, 22, 23, and 24, respectively.

In certain embodiments of the present general inventive concept, the color toners and the transparent toner are mono-component toners. A colorant to color a binder resin, internal additives such as charge control agent (CCA), wax or the like, and external additives such as silica and titanium oxide (TiO₂) may be added to the color toners. The composition of the transparent toner may be similar to the composition of the color toners with the exception of the colorant and the additives to adjust the gloss. The transparent toner may be made of a low molecular base resin so as to improve the gloss, and the content of wax of the transparent toner may be greater than the content of wax of the color toners. The color toners and the transparent toner are charged to a negative (−) or positive (+) polarity. The case where the color toners and the transparent toner are charged to the negative (−) polarity will now be described. Charging amounts of the color toners and the transparent toner may be about −10 to −25 μC/g, as measured by a suction type Faraday Gauge, and a layer of toner on a developing roller 42 may be applied to about 0.5 to 1 mg/cm².

Each of the photosensitive drums 10, 11, 12, 13, and 14 is an example of a electrostatically chargeable body on which an electrostatic latent image may be formed, and may be realized by, for example, an organic photosensitive body or an amorphous silicon photosensitive body having a long life span. Each of the photosensitive drums 10, 11, 12, 13, and 14 corresponds to each of the developing units 20, 21, 22, 23, and 24.

Each of the exposing units 30, 31, 32, 33, and 34 may scan light modulated according to image information about transparent (T), black (B), magenta (M), cyan (C), and yellow (Y) colors, respectively, onto the photosensitive drums 10, 11, 12, 13, and 14 to form thereby corresponding electrostatic latent images. A laser scanning unit (LSU) that uses a laser diode as a light source may be used in each of the exposing units 30, 31, 32, 33, and 34.

Each of charging rollers 41 is an example of a charging unit to charge each of the photosensitive drums 10, 11, 12, 13, and 14 to a uniform surface electric potential. The charging rollers 41 may be in contact with the photosensitive drums 10, 11, 12, 13, and 14, respectively. A charging bias voltage may be applied to each of the charging rollers 41.

Each of the developing units 20, 21, 22, 23, and 24 may include a developing roller 42 and a supply roller 43. The supply roller 43 attaches the toner maintained in each of the developing units 20, 21, 22, 23, and 24 to the developing roller 42. The developing units 20, 21, 22, 23, and 24 may further comprise a regulating means 45 which regulates the amount of the toner attached to the surface of the developing roller 42 to form a layer of toner having a uniform thickness. The regulating means 45 may be an elastic plate or roller, which is elastically in contact with the developing roller 42. In addition, the developing units 20, 21, 22, 23, and 24 may further comprise at least one carrying means (not illustrated) which carries the toner maintained in each of the developing units 20, 21, 22, 23, and 24 into a region where the developing roller 42 and the supply roller 43 face each other. When a contact developing technique is used, the developing rollers 42 are in contact with the photosensitive drums 10, 11, 12, 13, and 14. A developing bias voltage, which is used to supply the transparent toner and the color toners maintained in the developing units 20, 21, 22, 23, and 24 to the electrostatic latent images on the photosensitive drums 10, 11, 12, 13, and 14, is applied to each of the developing rollers 42. The application of the developing bias voltage produces an electric potential difference between the developing rollers 42 and the electrostatic latent images so that the toners are detached from the surface of the developing rollers 42 and are attracted to the electrostatic latent images. The electrostatic latent images are thereby developed with the toners. When a non-contact developing technique is used, a developing gap is maintained between the developing rollers 42 and each of the photosensitive drums 10, 11, 12, 13, and 14. A bias voltage in which an AC current and a DC current are mixed may be used as a developing bias voltage. An exemplary embodiment of the present general inventive concept in which the contact developing technique is used will now be described.

An intermediate transfer belt 60 is an example of an intermediate transfer medium to which toner images developed on the photosensitive drums 10, 11, 12, 13, and 14 may be temporarily transferred. The intermediate transfer belt 60 may face the photosensitive drums 10, 11, 12, 13, and 14, and may be supported by support rollers 61 and 62. Each of transfer rollers 70, 71, 72, 73, and 74 may face each of the photosensitive drums 10, 11, 12, 13, and 14 and the intermediate transfer belt 60 may be positioned therebetween. A first transfer bias voltage, which is used to attract the toner images developed on the photosensitive drums 10, 11, 12, 13, and 14 to the intermediate transfer belt 60, may be applied to each of the transfer rollers 70, 71, 72, 73, and 74. For example, a conductive metal roller or a rubber roller on which an elastic, semi-conductive rubber is disposed on a metal shaft may be used as each of the transfer rollers 70, 71, 72, 73, and 74.

A final transfer roller 77 may be positioned to face the intermediate transfer belt 60. A printing medium stacked on a paper feeding cassette 91 may be carried by a carrying means (not illustrated) between the final transfer roller 77 and the intermediate transfer belt 60. A second transfer bias voltage, which is used to transfer the toner images attached to the intermediate transfer belt 60 to the printing medium, may be applied to the final transfer roller 77. A fusing unit 92 may fuse the toner images on the printing medium by, for example, applying heat and pressure to the printing medium. A cleaning blade 44 is an example of a cleaning means which eliminates the toner remaining on the surface of each of the photosensitive drums 10, 11, 12, 13, and 14 after an intermediate transfer operation.

An exemplary printing method according to the embodiment of the present general inventive concept illustrated in FIG. 1 will now be described.

When a printing instruction is input to the exemplary image forming apparatus, image information pertaining to transparent (T), black (B), magenta (M), cyan (C), and yellow (Y) colors is processed by, for example, a control means (not illustrated) in a manner that precludes color toner images from occupying the uppermost layer. Thus, image information concerning transparent (T) color is used to develop a transparent toner image in regions where color toners such as black (B), magenta (M), cyan (C), and yellow (Y) are attached.

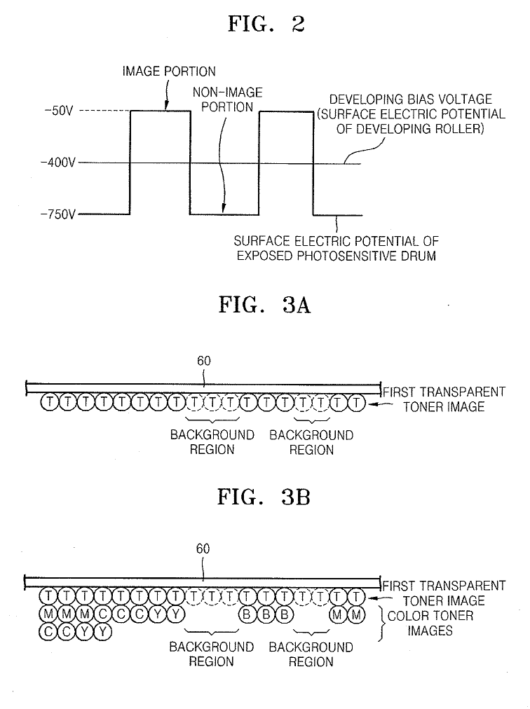

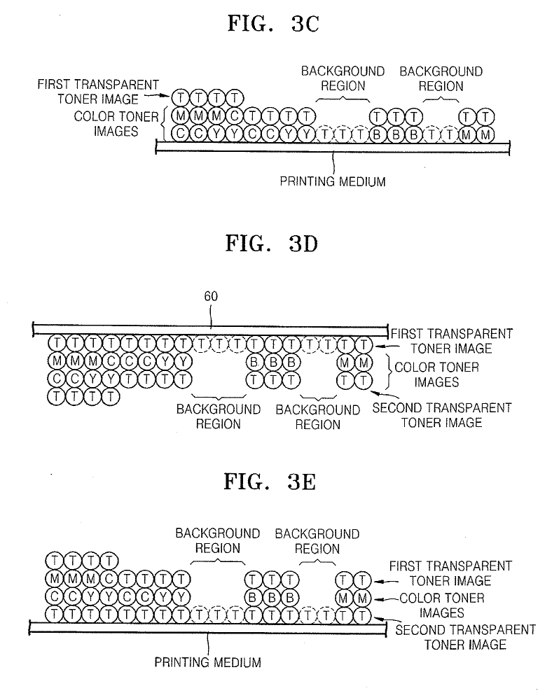

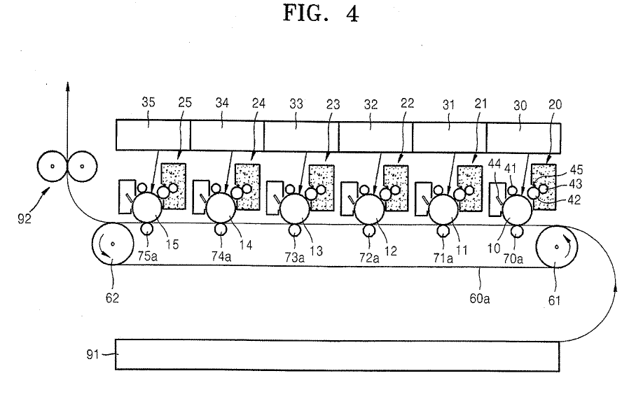

According to the image information pertaining to the transparent (T) color, the exposing unit 30 scans light onto the photosensitive drum 10 to form a corresponding electrostatic latent image subsequent to the charging roller 41 charging the photosensitive drum 10 to a uniform electric potential. The surface electric potential of the photosensitive drum 10 may be charged by the charging roller 41 to, for example, approximately −750V, as illustrated in FIG. 2. The electric potential of an image portion onto which light is scanned by the exposing unit 30 may be, for example, approximately −50V. A non-image portion onto which light is not scanned is maintained at the surface electric potential of the charged photosensitive drum 10. An intermediate electric potential may be applied to each developing roller 42 of the developing unit 20 as the developing bias voltage and may be between the electric potential of the image portion and the electric potential of the non-image portion, for example, −400V. Since the transparent toner is charged to a negative (−) polarity with respect to the developing bias voltage, the transparent toner maintained in the first developing unit 20 is attracted to the image portion. A first transfer bias voltage having an opposite polarity to the charging polarity of the transparent toner is applied to the transfer roller 70. As such, a first transparent toner image developed on the photosensitive drum 10 is transferred to the intermediate transfer belt 60, as illustrated in FIG. 3A.

Next, for example, according to the image information pertaining to the black (B) color, the exposing unit 31 scans light onto the photosensitive drum 11 to form a corresponding electrostatic latent image subsequent to the charging roller 41 charging the photosensitive drum 11 to a uniform electric potential. The surface electric potential of the charged photosensitive drum 11 may be identical to that illustrated in FIG. 2. Since the black toner is charged to a negative (−) polarity with respect to the developing bias voltage, the black toner maintained in the first developing unit 21 is attracted to the image portion when the developing bias voltage is applied to the developing roller 42. A first transfer bias voltage having an opposite polarity to the charging polarity of the black toner may be applied to the transfer roller 71. Consequently, the black toner image developed on the photosensitive drum 11 is transferred to the intermediate transfer belt 60. At this time, the black toner image is disposed over the first transparent toner image. The black toner that remains on the photosensitive drum 11 after a transfer operation is eliminated by the cleaning blade 44. According to image information pertaining to the magenta (M), cyan (C), and yellow (Y) colors, respectively, similar operations to those described above for the black (B) color may be performed by the photosensitive drums 12, 13, and 14, the exposing units 32, 33, and 34, and the developing units 22, 23, and 24, respectively, at time intervals each of which may be given by the formula (distance between photosensitive drums)/(carrying speed of intermediate transfer belt), so as to meet color registration requirements.

Through the above-described operations, the first transparent toner image and the color toner images are sequentially stacked on the intermediate transfer belt 60, as illustrated in FIG. 3B. When the first transparent toner image and the color toner images are conveyed on the intermediate transfer belt 60 to a position where the final transfer roller 77 and the intermediate transfer belt 60 face each other, the printing medium supplied from the paper feeding cassette 91 reaches the region. A second transfer bias voltage having an opposite polarity to the charging polarities of the first transparent toner image and the color toner images are applied to the final transfer roller 77, and the first transparent toner image and the color toner images are transferred to the printing medium. The color toner images may then be transferred to the surface of the printing medium and the first transparent toner image may be transferred over the color toner images, as illustrated in FIG. 3C.

As the printing medium passes through the fusing unit 92, the first transparent toner image and the color toner images may be fused on the printing medium by heat and pressure and a printing operation is ended. The color toners that are not transferred to the printing medium and remain on the intermediate transfer belt 60 are eliminated by a cleaning member 93.

Since the color toner images are covered by the first transparent toner image through the above-described operations, problems encountered in a conventional printing method, such as diminished gloss due to the color toner images occupying the uppermost layer, can be solved. As such, the gloss of a printed image can be improved and image quality can also be improved.

In certain embodiments of the present general inventive concept, image information pertaining to the transparent (T) color is used to develop a transparent toner image in a region in which color toners of black (B), magenta (M), cyan (C), and yellow (Y) are attached and in a background region in which the color toners are not attached. As such, the first transparent toner image is formed even in the background region, as indicated by dotted lines of FIGS. 3A through 3C, so that the gloss of the printed image can be improved over the entire surface thereof.

In addition, once the operations illustrated in FIGS. 3A and 3B have been performed, a second transparent toner layer may be further formed on the color toner images. To this end, for example, the photosensitive drum 10, the exposing unit 30, and the developing unit 20 may perform a developing operation once again. That is, as the intermediate transfer belt 60 travels, the surface of the intermediate transfer belt 60 on which the first transparent toner image and the color toner images are sequentially stacked faces the first photosensitive drum 10 again. At this time, the final transfer roller 77 and the cleaning member 93 are separated from the intermediate transfer belt 60 by, for example, a driving mechanism 88, and the conveyance of the printing medium from the paper feeding cassette 91 is delayed. The driving mechanism 88 may be implemented through any suitable means to separate the final transfer roller 77 from the intermediate transfer belt 60, such as by a solenoid coupled to the final transfer roller 77. Image information about the second transparent toner may be used to develop the transparent toner image in a region in which color toners of black (B), magenta (M), cyan (C), and yellow (Y) are attached. The exposing unit 30 may scan light onto the photosensitive drum 10 to form the corresponding electrostatic latent image subsequent to the photosensitive drum 10 being charged by the charging roller 41 to a uniform electric potential. When a developing bias voltage is applied to the developing roller 42, the transparent toner stored in the developing unit 20 is attracted to the electrostatic latent image. A first transfer bias voltage having an opposite polarity to the charging polarity of the transparent toner may be applied to the transfer roller 70, and the second transparent toner image developed on the photosensitive drum 10 is transferred to the intermediate transfer belt 60, as illustrated in FIG. 3D. The first transparent toner image, the color toner images, and the second transparent toner image are sequentially stacked on the intermediate transfer belt 60. While the second transparent image developing operation is performed, the photosensitive drums 11, 12, 13, and 14, the developing units 21, 22, 23, and 24, and the exposing units 31, 32, 33, and 34 are operated into an idle state and do not perform a developing operation.

Once the second transparent image has been applied to the transfer belt 60, the final transfer roller 77 may face the intermediate transfer belt 60 through positioning by the driving mechanism 88. When the first transparent toner image, the color toner images, and the second transparent toner image are conveyed on the intermediate transfer belt 60 to where the final transfer roller 77 and the intermediate transfer belt 60 face each other, the printing medium supplied from the paper feeding cassette 91, which is not longer delayed, reaches the region. A second transfer bias voltage having an opposite polarity as the charging polarities of the first transparent toner image, the color toner images, and the second transparent toner image may be applied to the final transfer roller 77, and the first transparent toner image, the color toner images, and the second transparent toner image are transferred to the printing medium. Then, the second transparent toner image may be transferred to the surface of the printing medium and the color toner images and the first transparent toner image are sequentially transferred onto the second transparent toner image, as illustrated in FIG. 3E. As the printing medium passes through the fusing unit 92, the first transparent toner image, the color toner images, and the second transparent toner image are fused on the printing medium by heat and pressure and the printing operation is ended.

The gloss of the printed image is improved by the first transparent toner image which covers the color toner images through the above-described operations. In addition, since paper that is generally used as the printing medium is made of a fibrous material (pulp), roughness exists on the surface of the paper. The second transparent toner image is softened in the fusing operation and fills the unevenness of the surface of the printing medium. Since the color toner images are fused on the smoothened second transparent toner image, the surface uniformity of the printed image is improved. Thus, the quality of the printed image can be improved.

In certain embodiments of the present general inventive concept, a separate photosensitive drum 15, developing unit 25, and exposing unit 35 may be provided to develop and transfer the second transparent toner image as illustrated in FIG. 1. For example, after the yellow toner image is transferred, the second transparent toner image may be transferred onto the intermediate transfer belt 60. In addition, it will be understood by those of ordinary skill in the art that the transparent toner image can be transferred to the background region during either the first transparent toner image transfer operation or the second transparent toner image transfer operation.

The above-described method of printing the image by transferring the transparent toner may be utilized to implement secret printing. When a printing instruction is input, the printed image may be divided into a viewable printing region and a secret printing region by a control means (not illustrated). In the viewable printing region, the control means processes image information so that only the color toner images are transferred to the printing medium. In the secret printing region, the control means processes image information so that the first transparent toner image, the color toner images, and the second transparent toner images are transferred onto the printing medium in a stacked relationship. As such, the second transparent toner image, the color toner images, and the first transparent toner image, which are sequentially stacked in a region of the printing medium which corresponds to the secret printing region, pass through the fusing unit 92, and a primary printing operation is ended, as illustrated in FIG. 3E. In certain embodiments of the present general inventive concept, the transparent toner is made of a lower molecular base resin than the color toners so as to improve the gloss, and the content of wax is greater than the content of wax of the color toners. Thus, the melting point of the transparent toner is lower than the melting point of the color toners. When heat is applied to the printed image, the transparent toner is melted and the viscosity of the first and second transparent toner images is lowered. The color toner between the first and second transparent toner images flows out of its original location. As such, the color toner images in the secret printing region are distorted and it is difficult to read the printed content in the secret printing region. An image in the viewable printing region is maintained without changes.

To distort the images in the secret printing region, the printing medium with the printed image may be directed through the fusing unit 92 once again. The printing medium on which the image is printed may be restacked on the paper feeding cassette 91 and may thus be carried to the fusing unit 92. Alternatively, the printing medium on which the image is printed may be carried to the fusing unit 92 via an inversion path 94.

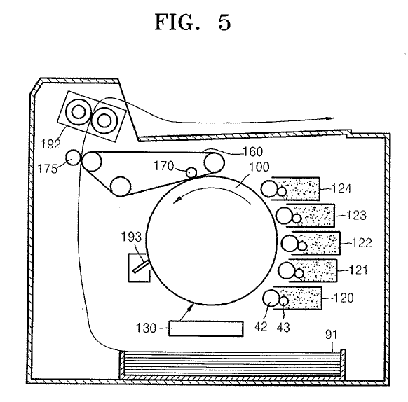

The previously described technique to develop a transparent toner image and color toner images may also be applied to a single pass image forming apparatus having a direct transfer technique in which a toner image is directly transferred to a printing medium, i.e., the intermediate transfer operation is not performed, as illustrated in FIG. 4. Referring to FIG. 4, the printing medium withdrawn from the paper feeding cassette 91 is carried by a carrying belt 60a. Each of the transfer rollers 70a, 71a, 72a, 73a, 74a, and 75a faces each of the photosensitive drums 11, 12, 13, 14, and 15 and the printing medium and the carrying belt 60a are positioned therebetween. The transparent toner image and the color toner images respectively developed on the photosensitive drums 10, 11, 12, 13, 14, and 15 may be directly transferred to the printing medium by a transfer bias voltage applied to each of the transfer rollers 70a, 71a, 72a, 73a, 74a, and 75a. The first transparent toner image may be transferred to the color toner images by the photosensitive drum 15, the developing unit 25, the exposing unit 35, and the transfer roller 75a after the color toner images are transferred onto the printing medium. In addition, the second transparent toner image may be transferred to the printing medium by the photosensitive drum 10, the developing unit 20, the exposing unit 30, and the transfer roller 70a before the color toner images are transferred to the printing medium.

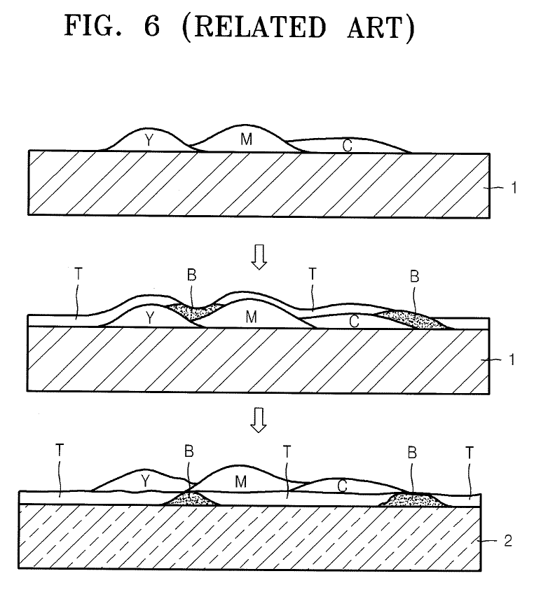

The above-described printing method using the transparent toner and the color toners may also be applied to a multiple pass color image forming apparatus. FIG. 5 illustrates an exemplary structure of an electrophotographic image forming apparatus according to another embodiment of the present general inventive concept. The exemplary electrophotographic image forming apparatus is a multiple pass color image forming apparatus which comprises a photosensitive drum 100, an exposing unit 130, and developing units 120, 121, 122, 123, and 124. Referring to FIG. 5, the developing units 120, 121, 122, 123, and 124 are disposed around the photosensitive drum 100. A transparent toner may be maintained in the first developing unit 120. Color toner images such as black (B), magenta (M), cyan (C), and yellow (Y) may be maintained in the second developing units 121, 122, 123, and 124, respectively.

The exposing unit 130 may scan light onto the photosensitive drum 100 to form an electrostatic latent image corresponding to the transparent (T) image information subsequent to the photosensitive drum 100 being charged by a charging roller 141 to a uniform electric potential. The developing unit 120 develops the electrostatic latent image by supplying the transparent toner to the electrostatic latent image. The transparent toner image may be transferred onto an intermediate transfer belt 160 by a first transfer bias voltage applied to an intermediate transfer belt 170. As illustrated in FIG. 3A, a first transparent toner image which corresponds to a sheet of paper is transferred onto the intermediate transfer belt 100. A cleaning member 193 eliminates the transparent toner that remains on the photosensitive drum 100 after the transfer operation. When the above-described operations are sequentially performed on black (B), magenta (M), cyan (C), and yellow (Y) colors, the first transparent toner image and the color toner images are sequentially stacked on an intermediate transfer belt 160, as illustrated in FIG. 3B. As illustrated in FIG. 3C, the first transparent toner image and the color toner images are transferred to the printing medium using a final transfer roller 175 and are fused on a fusing unit 192, thereby printing desired color images whose gloss is improved.

As illustrated in FIG. 3B, after the first transparent toner image and the color toner images are sequentially transferred onto the intermediate transfer belt 160, the second transparent toner image may be developed using the developing unit 125 and may be transferred onto the intermediate transfer belt 160. As such, the first transparent toner image, the color toner images, and the second transparent toner image are ordered on the intermediate transfer belt 160 as illustrated in FIG. 3D. As illustrated in FIG. 3E, the first transparent toner image, the color toner images, and the second transparent toner image are transferred to the printing medium using a final transfer roller 175 and are fused by a fusing unit 192, thereby printing desired color images whose gloss and surface uniformity are improved.

It will be understood by those of ordinary skill in the art that the printing method in the secret printing region that has been described with regard to the exemplary single pass color image forming apparatus can also be applied to the multiple pass color image forming apparatus illustrated in FIG. 5.

Either one of a contact developing technique in which the developing roller 42 and the photosensitive drum 100 are in contact with each other and a non-contact developing technique in which the developing roller 42 and the photosensitive drum 100 are separated from each other by a predetermined developing gap may be used with the present general inventive concept without departing from the spirit and intended scope thereof. The developing units 120, 121, 122, 123, and 124 may be moved by a suitable driving mechanism, such as was described with reference to FIG. 1, to a stoppage location at which they are separated from the photosensitive drum 100 or to a developing location at which the developing roller 42 contacts the photosensitive drum 100 or, in the case of the non-contact developing technique, is separated from the photosensitive drum 100 by a developing gap.

Although a color image forming apparatus having a plurality of color developing units has been described in the exemplary embodiments above, the scope of the present general inventive concept is not limited thereto. The present general inventive concept can also be applied to a single color image forming apparatus having one color developing unit. In addition, the scope of the present general inventive concept is not limited by the above-described developing sequence of black (B), magenta (M), cyan (C), and yellow (Y) toners.

As described above, in the printing method to the electrophotographic image forming apparatus according to the present general inventive concept, the gloss of the printed image is improved by the first transparent toner image which covers the color toner images. In addition, the second transparent toner image is transferred to the surface of the printing medium and fills the unevenness of the printing medium such that the surface uniformity of the printed image is improved. Furthermore, in the secret printing region, the color toner images are transferred and fused between the first and second transparent toner images and then are heated such that secret-required portions of the color toner images are distorted.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printing method to form an electrophotographic image, the method comprising:
transferring a second transparent toner image to a surface of a printing medium;
transferring color toner images on the second transparent toner image according to image information; and
transferring a first transparent toner image onto the color toner images.

2. The method of claim 1, wherein the second transparent toner image is transferred only to a region of the printing medium on which the color toner images are transferred.

3. The method of claim 2, wherein the first transparent toner image is transferred only to a region of the printing medium on which the color toner images are transferred.

4. The method of claim 2, wherein the first transparent toner image is transferred to a region of the printing medium on which the color toner images are transferred and a background region of the printing medium on which the color toner images are not transferred.

5. The method of claim 1, wherein the second transparent toner image is transferred to the entire surface of the printing medium.

6. The method of claim 5, wherein the first transparent toner image is transferred only to a region of the surface of the printing medium on which the color toner images are transferred.

7. A printing method to form an electrophotographic image, the method comprising:
dividing a printed image into a viewable printing region and a secret printing region and sequentially transferring a transparent toner image, color toner images, and another transparent toner image onto a region corresponding to the secret printing region of the printing medium;
passing the printing medium through a fusing unit and fusing the printed image on the printing medium; and
distorting the image in the secret printing region by applying heat to the printing medium.

8. The method of claim 7, wherein the distorting of the image in the secret printing region comprises:
repeating the passing of the printing medium through the fusing unit subsequent to the fusing being performed.

9. A method of forming an electrophotographic image, comprising:
applying at least one color toner to a printing medium in regions thereon corresponding to image data; and
applying transparent toner to the color toner in the regions corresponding to the image data to preclude the color toner from occupying an uppermost toner layer on the printing medium.

10. The method of claim 9, further comprising:
applying the transparent toner to regions of the printing medium excluded from the application of the color toner.

11. The method of claim 10, further comprising:
applying the transparent toner to the printing medium in the regions corresponding to the image data prior to the applying of the color toner thereto.

12. The method of claim 11, further comprising:
melting the transparent toner; and
melting the color toner subsequent to the melting of the transparent toner.

13. A method of forming an electrophotographic image, comprising:
providing a transparent toner to regions of an electrostatic latent image corresponding to color regions of a printed image; and
providing at least one color toner to the regions of the electrostatic latent image corresponding to the color regions of the printed image only where the transparent toner is provided on the electrostatic latent image.

14. The method of claim 13, further comprising:
providing the transparent toner to regions of the electrostatic latent image excluded from the regions corresponding to the colored regions.

15. The method of claim 13, further comprising:
providing the transparent toner to the regions of the electrostatic latent image corresponding to the colored regions over the colored toner provided thereon.

16. The method of claim 15, further comprising:
applying heat to the transparent toner to melt the transparent toner prior to melting the colored toner.

17. The method of claim 16, further comprising:
repeating the applying of the heat to further melt the transparent toner subsequent to the melting of the colored toner.

18. A method to distort regions of a printed image, comprising:
applying a first toner layer having a first melting point to a printing medium;
applying a second toner layer having a second melting point greater than the first melting point on the first toner in regions thereon corresponding to the printed image;
applying a third toner layer having a third melting point less than the second melting point on the second toner layer on at least the regions thereof corresponding to the printed image; and
applying heat to the printing medium.

19. The method of claim 18, further comprising:
providing a transparent toner as the first toner layer and the third toner layer.
